(19) United States
(12) Patent Application Publication
(10) Pub. No.: US 2021/0028977 A1
(43) Pub. Date: Jan. 28, 2021

(54) REDUCED QUORUM FOR A DISTRIBUTED SYSTEM TO PROVIDE IMPROVED SERVICE AVAILABILITY

(71) Applicant: Hewlett Packard Enterprise Development LP, Houston, TX (US)

(72) Inventors: Eugene Ortenberg, McLean, VA (US); Bradford Glade, Marlborough, MA (US); Timothy Clark, Ithaca, NY (US)

(21) Appl. No.: 16/523,054

(22) Filed: Jul. 26, 2019

(51) Int. Cl. H04L 12/24; H04L 29/08

(52) U.S. Cl. CPC H04L 41/0654; H04L 67/16; H04L 41/30; H04L 67/10

(57) ABSTRACT

Example implementations relate to maintaining service availability. According to an example, a distributed system including multiple nodes establishes a number of the nodes to operate as voters in a quorum evaluation process for a service supported by the nodes. A first proper subset of the nodes is identified to operate as the voters and the remainder of the nodes do not vote in the quorum evaluation process. Responsive to detecting, by a voter, existence of a failure that results in the voter being part of a second proper subset of the nodes and that calls for a quorum evaluation, the voter determines whether the second proper subset of nodes has a quorum by initiating the quorum evaluation process. When the determining is affirmative, the second proper subset continues to support the service; otherwise, the second proper subset discontinues to make progress on behalf of the service.

### BACKGROUND

Distributed systems commonly replicate their resources across many computer “nodes” in order to keep service available in the presence of various types of failures (e.g., node and/or network failures). Highly-available distributed systems may be designed to tolerate network partition failures, which may split the nodes of a distributed system into two or more mutually disjoint subsets. A highly-available distributed system may continue to provide service in the presence of these types and other types of failures without jeopardizing consistency of its responses. This means that if a network partition takes place, the service operates in a way that does not result in conflicts upon recovery.

Quorum may be employed as a solution to this problem. With quorum, nodes in a distributed system are given votes. For example, in an “all-nodes-vote” quorum scheme, each node of the distributed system can be assigned the same number of votes or votes can be assigned according to weights (with some nodes getting more votes than others). When a network partition occurs, nodes in each subset (that is, on each side of the partition) count the votes they have. If a given subset has the majority of votes, it is said to have quorum and it is allowed to continue service. Subsets that do not have quorum stop making progress on behalf of the service and wait until they rejoin the majority.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1A is a block diagram depicting a distributed system with seven nodes located in three different failure domains operating in accordance with an “all-nodes-vote” quorum scheme.

FIG. 1B is a block diagram depicting the distributed system of FIG. 1A after a network partition.

FIG. 1C is a block diagram depicting the distributed system of FIG. 1B after a node failure.

FIG. 2A is a block diagram depicting a distributed system with seven nodes located in three different failure domains and in which only a subset of the nodes are voters in accordance with an embodiment.

FIG. 2B is a block diagram depicting the distributed system of FIG. 2A after a network partition.

FIG. 2C is a block diagram depicting the distributed system of FIG. 2B after a non-voter node failure.

FIG. 3A is a block diagram depicting a distributed system with nine nodes located in three different failure domains and in which only a subset of the nodes are voters in accordance with an embodiment.

FIG. 3B is a block diagram depicting the distributed system of FIG. 3A after a network partition.

FIG. 3C is a block diagram depicting the distributed system of FIG. 3B after a non-voter node failure.

FIG. 4 is a block diagram depicting a distributed system with nine nodes supporting two different services in accordance with an embodiment.

FIG. 5 is a flow diagram illustrating distributed system processing in accordance with an embodiment.

FIG. 6 is a block diagram of a node of a distributed system in accordance with an embodiment.

FIG. 7 is a block diagram illustrating a hyperconverged infrastructure (HCI) node that may represent the nodes of a distributed system in accordance with an embodiment.

### DETAILED DESCRIPTION

Embodiments described herein are generally directed to systems and methods for reducing quorum for a distributed system by configuring at system startup a proper subset of the nodes of the distributed system to be voters, which participate in a quorum evaluation process, and the remainder of the nodes of the distributed system to be non-voters, which do not participate in the quorum evaluation process. In some embodiments, the determination of this subset can be made during the run-time of the system and can also be applied to new service instantiations dynamically.

In the following description, numerous specific details are set forth in order to provide a thorough understanding of example embodiments. It will be apparent, however, to one skilled in the art that embodiments described herein may be practiced without some of these specific details. In other instances, well-known structures and devices are shown in block diagram form.

An “all-nodes-vote” quorum scheme used in the context of distributed systems is sub-optimal in various common failure scenarios. Consider a distributed system S, consisting of 2M+1 nodes N₁, . . . , N_{2M+1}. For example, S may be a cluster, whose nodes are divided into two independent failure domains. Each failure domain is often deployed in a way that failures affecting one failure domain are unlikely to affect the other. For instance, each failure domain can be deployed in a different equipment rack, a different equipment room or a different building in a metropolitan area, etc. In existing distributed systems, all nodes usually vote as part of a quorum evaluation process. Notably, however, the availability of a distributed system with this “all-nodes-vote” quorum scheme gets worse at higher node scales (that is, as M gets larger). Suppose, for example, a network partition occurs and S splits into two subsets: S1={N₁, . . . , N_{M}} and S2={N_{M+1}, . . . , N_{2M+1}}. Assuming each node is given a single vote, S2 has quorum and can proceed servicing requests. S1 has to stop service because it does not have quorum. Suppose, further, there is a second failure and one of the nodes in S2 fails. When this happens, S2 loses quorum and has to stop servicing requests. Hence, service becomes unavailable after only two consecutive failures in the context of this “all-nodes-vote” quorum scheme example. As those skilled in the art will appreciate, the larger M is, the more likely that this scenario will take place as the probability of at least one out of the M nodes failing increases with M (albeit, not linearly).

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

A “distributed system” generally refers to a collection of autonomous computing elements (also referred to herein as “nodes”) that appears to its users (e.g., people or applications) as a single coherent system. The nodes of a distributed system may include components executed on or represented by different computer elements or computer systems that are coupled in communication and which communicate and coordinate their actions. The nodes of a distributed system interact with one another in order to achieve a common goal, for example, support and/or provision of a particular service. The nodes of a distributed systems may be coupled in communication via a communication link (e.g., a bus, a switch fabric, a wireless or wired network, or a combination thereof) and are typically spread over multiple failure domains to enhance service availability. For example, geographically distributed nodes may be coupled in communication via one or more private and/or public networks (e.g., the Internet). There are various types of distributed systems, including distributed computing systems, distributed information systems and distributed pervasive (or ubiquitous) systems. Examples of distributed computing systems, which are typically used for high performance computing tasks, include cluster and cloud computing systems and grid computing systems. Examples of distributed information systems, which are typically used for management and integration of business functions, include transaction processing systems and Enterprise Application Integration. Examples of distributed pervasive (or ubiquitous) systems, which typically include mobile and embedded systems, include home systems and sensor networks. Non-limiting examples of a distributed system include a cluster of HyperConverged Infrastructure (HCI) nodes (e.g., the HPE SimpliVity 380 or the HPE SimpliVity 2600, all of which are available from Hewlett Packard Enterprise of San Jose, Calif.).

A “service” generally refers to a process or function performed by or otherwise supported in whole or in part by a distributed system. For example, the nodes of the distributed system may make some contribution to a service provided by its user(s) (e.g., upstream systems or applications) in the form of providing, server services, storage services, storage networking services, computing resources, storage resources and/or networking resources on behalf of the user(s). Alternatively, the nodes of the distributed system may be responsible for and effectively represent the entirety of the service. Non-limiting examples of a service include a webservice, cloud management, cloud infrastructure services, a distributed application, a managed service, and transaction processing. Embodiments described herein may be particularly well-suited to services requiring strong consistency.

A “node” generally refers to an autonomous computing element. The nodes of a distributed system may be computer systems (e.g., clients, servers or peers) in virtual or physical form, one or more components of a computer system, computing elements, hardware devices, software entities or processes, or a combination thereof. Non-limiting examples of nodes include a software process (e.g., a client or a server), a virtual machine, a virtual controller of a storage software stack, a storage server, a hyperconverged platform, a data virtualization platform, a sensor, and an actuator.

A “cluster” is a subclass of a distributed system and generally refers to a collection of multiple nodes that work together. Some reasons for clustering nodes include high availability, load balancing, parallel processing, systems management and scalability. “High-availability clusters” (also referred to as failover clusters or HA clusters) improve the availability of the cluster approach. As described further below, they operate by having redundant nodes which are then used to maintain the availability of service despite the occurrence of various failure scenarios (e.g., a node failure and/or a network partition) for which the cluster may be designed to tolerate.

A “failure domain” generally represents a collection of distributed system elements, which tend to fail together for specific failure conditions. For instance, in the presence of a localized flood limited to a particular building, hardware components deployed in the particular building will fail together; however, components deployed in a different building would be unaffected by this failure. A failure domain may include a set of resources that provide a service to users and fails independently of other failure domains that provide that same service. In order for failure domains to be independent, failure domains should not share resources, such as network or power. Since network and power are common sources of faults, fault boundaries often align to physical structural elements such as buildings, rooms, racks, and power supplies. Non-limiting examples of failure domains include different chassis within the same equipment rack, different equipment racks within the same equipment room, different equipment rooms within the same building, different buildings within the same geographical region, and different buildings (e.g., data centers) in different geographical regions.

A “quorum” generally refers to the minimum number of votes that a particular type of operation has to obtain in order to be allowed in the context of a distributed system. According to one embodiment, a quorum is a strict majority of the voting nodes. Examples of operations that require quorum include, but are not limited to, continuing service after a network partition, reconstitution of the cluster, continuing service after one or more voting nodes have failed, and dynamically updating the number of voters during runtime.

A “quorum evaluation process” generally refers to a consensus algorithm. A non-limiting example of a quorum evaluation process is the Paxos algorithm. Another example technique for solving the consensus problem is known as “Virtual Synchrony.”

An “arbiter” generally refers to a process or node that acts as a witness to maintain quorum for a distributed system to ensure data availability and data consistency should a node of the distributed system experience downtime or become inaccessible. According to one embodiment, the arbiter provides a vote and is implemented in the form of a server for tie-breaking and located in a failure domain separate from the nodes of the distributed system that respond to requests relating to the service supported by the distributed system. In this manner, should equal sized groups of nodes become partitioned from each other, the arbiter allows one group to achieve quorum and form a reconstituted cluster, while the other group is denied quorum and cannot form a reconstituted cluster.

A “voter” or a “voting node” generally refers to a node of a distributed system that participates in the quorum evaluation process employed by the distributed system for a particular service supported or provided by the distributed system. When only one service is supported or provided by the distributed system, the limitation above relating to “for a particular service” is of no consequence; however, when the distributed system supports or provides multiple services, embodiments described herein allow for the node's role as a voter or non-voter to be defined on a service-by-service basis. As such, a node may be a voter for a first service supported or provided by the distributed system and may be a non-voter for a second service. Alternatively, the node may be a voter for both the first and second services. Finally, the node may be a non-voter for both the first and second services.

A “non-voter” or a “non-voting node” generally refers to a node of a distributed system that does not participate in the quorum evaluation process employed by the distributed system for a particular service. Since non-voting nodes do not participate in the quorum evaluation process, the amount of communications required for the quorum evaluation process is limited, thereby providing better scalability.

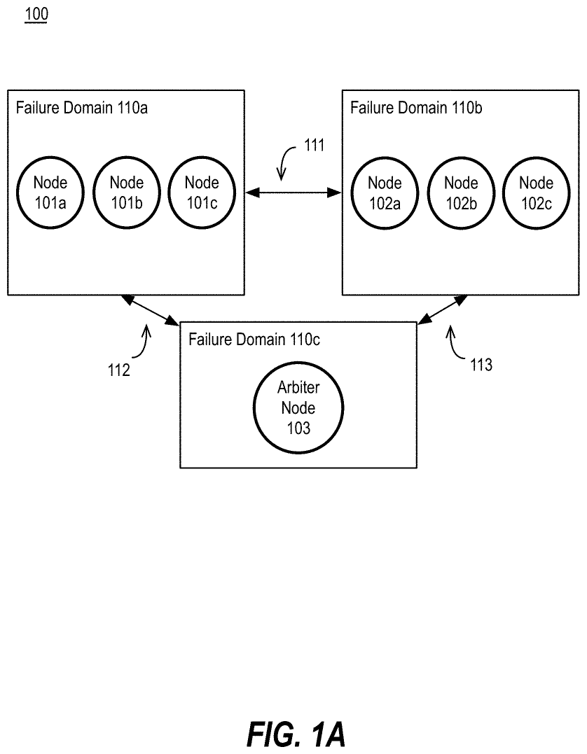

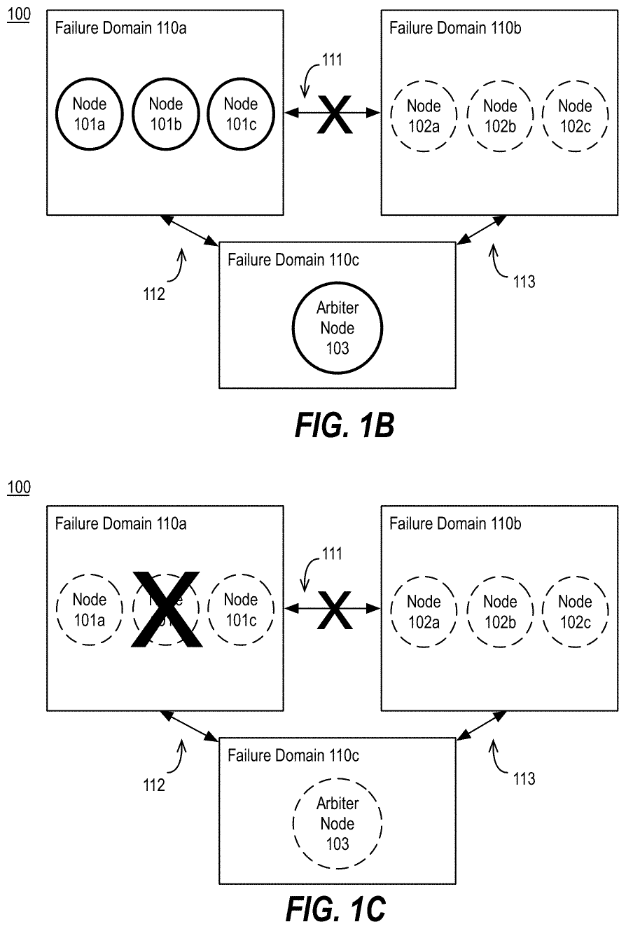

Having provided an overview of the general sub-optimal nature of the “all-nodes-vote” quorum scheme in the context of a set of 2M+1 nodes and with the above terminology in mind, for purposes of illustration, a concrete example of a limitation of the existing “all-nodes-vote” quorum scheme will now be described with reference to FIG. 1A-1C. In this example, nodes shown with bold outlines are part of an HA cluster that have quorum and are actively providing or supporting a service. Nodes shown with dashed outlines were part of the initial HA cluster configuration, but as a result of a failure have lost quorum and no longer make progress on behalf of the service. That is, they are no longer permitted to process requests relating to the service.

FIG. 1A is a block diagram depicting a distributed system 100 with seven nodes 101a-c, 102a-c and 103 located in three different failure domains 110a-c operating in accordance with an “all-nodes-vote” quorum scheme. In the context of FIG. 1A, distributed system 100 is shown in a state in which a particular service supported or otherwise provided by nodes 101a-c, 102a-c and 103 is currently available and no failures have occurred.

As noted above, it is desirable to spread nodes of a distributed system across multiple failure domains in order to avoid a potential single point of failure for the entire distributed system in the event of a disaster. In the context of the present example, the distributed system 100 is spread across three failure domains 110a-c, with nodes 101a-c operating within failure domain 110a, nodes 102a-c operating within failure domain 110b and an arbiter node 103 operating within failure domain 110c.

Nodes 101a-c, 102a-c and 103 may be members of a HA cluster. Nodes 101a-c and nodes 102a-c make some contribution (e.g., processing, storage, etc.) to the operation of the particular service. Arbiter node 103 represents an arbiter. As such, arbiter node 103 acts as a witness to maintain quorum for distributed system 100 in the presence of network partitions.

Three communication links 111, 112 and 113 couple the failure domains 110a-c in communication. Communication link 111, between failure domain 110a and failure domain 110b, facilitates communications (e.g., message passing and/or heartbeats) between nodes 101a-c and nodes 102a-c. Communication link 112, between failure domain 110a and failure domain 110c, facilitates communications between nodes 101a-c and arbiter node 103. Communication link 113, between failure domain 110b and failure domain 110c, facilitates communications between nodes 102a-c and arbiter node 103. As described above, links 111, 112 and 113 may be implemented as a networked communications system.

FIG. 1B is a block diagram depicting the distributed system 100 of FIG. 1A after a network partition. A network partition generally refers to a network split due to the failure of a network device (e.g., an intermediate switch or router) and/or a communication link (e.g., a wireless or wired communication link). Regardless of the specific nature of the failure, for purposes of the present example it is sufficient to simply assume communications between failure domain 110a and failure domain 110b are sufficiently compromised that nodes 101a-c have the impression that nodes 102a-c have failed (e.g., as a result of no longer receiving heartbeat messages). Similarly, nodes 102a-c also have the impression that nodes 101a-c have failed. Such a failure results in a condition referred to as split-brain. Each side of the split-brain (each subset of nodes on opposite sides of the network partition) faces an ambiguous situation—they do not know whether the nodes on the other side of the network partition are still running. Without a proper approach for dealing with split-brain, each node in the cluster might otherwise mistakenly decide that every other node has gone down and attempt to continue the service that other nodes are still running.

Having duplicate instances of the service is unacceptable and can result in data corruption. When consistency is of more importance than service availability, an approach for moving forward is to use a quorum-consensus approach. As such, both subsets of nodes, in an attempt to maintain service availability, determine whether they are part of a majority of surviving nodes. This determination is performed by each node running a quorum evaluation process.

While a discussion of quorum evaluation processes performed by distributed systems to reach consensus or identify existence of a quorum is beyond the scope of this disclosure, it is instructive at this point to have at least a high-level overview of such processes, a non-limiting example of which is the Paxos algorithm. Assume a collection of processes each of which can propose values. A consensus algorithm, such as the Paxos algorithm, ensures that a single one among the proposed values is chosen. If no value is proposed, then no value should be chosen. If a value has been chosen, then processes should be able to learn the chosen value. The safety requirements for consensus are: (i) only a value that has been proposed may be chosen, (ii) only a single value is chosen, and (iii) a process never learns that a value has been chosen unless it actually has been. In the context of a failure, such as a network partition, the goal of the Paxos algorithm is for some number of the peer nodes to reach agreement on the membership of a reconstituted cluster.

Continuing with the present example, assuming arbiter node 103 has broken the 3-to-3 tie and has voted with nodes 101a-c, providing a 4 vote majority, this subset of the original set of nodes has quorum and continues to support the service using the current configuration of the HA cluster. Meanwhile, in parallel, nodes 102a-c have determined they do not have quorum and stop contributing to the service.

FIG. 1C is a block diagram depicting the distributed system of FIG. 1B after a node failure. In the context of the present example, it is now assumed in addition to the network partition that occurred in FIG. 1B one of the nodes (i.e., node 101b) of the reconstituted HA cluster has failed. Such a failure scenario requires another quorum evaluation. As the three remaining nodes (i.e., nodes 101a, 101c and 103) do not have quorum, they stop servicing requests and the service becomes unavailable. As such, after two consecutive failures (i.e., a network partition followed by a node failure), an HA cluster implementing the “all-nodes-vote” quorum scheme is no longer able to maintain service availability. Meanwhile, as noted above, service availability provided by the “all-nodes-vote” quorum scheme becomes worse in the above-described two consecutive failure scenario as the cluster size grows in view of the fact that the probability that a node in a given set fails increases with the size of that set.

In contrast to the “all-nodes-vote” quorum scheme as used in connection with FIGS. 1B-1C, in example embodiments described herein, rather than having all nodes participating in a distributed system vote as part of a quorum evaluation process, a proper subset of the nodes can be designated as voters (on a per service basis) in accordance with static, preconfigured administrative rules. As such, a particular node of a distributed system might be a voter for one service that it supports and a non-voter for another that it supports.

In an example embodiment, a different voting scheme is provided in which only a subset of nodes in S are given votes, while other nodes have no votes at all. While example embodiments described herein are not limited to a particular number of voters and non-voters, empirical evidence suggests the use of a “5-vote-quorum” scheme (i.e., in which five nodes of a distributed system are designated as voters and the remainder, if any, are designated as non-voters). In accordance with an example embodiment, the “5-vote-quorum” scheme has desirable performance characteristics when considering the most common failure scenarios and operates according to the following guidance:
Rule #1: In a distributed system with M<=2 (S has 2M+1 nodes, which is 5 or fewer) all of the nodes in the distributed system vote; and
Rule #2: In a distributed systems with M>2 (S has 2M+1 nodes, which is more than 5) only 5 nodes vote.

In order to understand the benefits of the impact of specifically configuring only a subset of nodes in S as voters upon system startup, for example, consider the same double failure scenario (i.e., a network partition followed by a node failure) discussed above. For example, assume that M is greater than 2 and that S1 has 2 voting members, while S2 has 3. Just as before, S2 continues to provide service and S1 stops when a network partition occurs. Should one of S2's voting nodes fail, S2 will also need to stop service; however, advantageously, S2 is able to continue to provide service if one or more of its non-voting nodes fails instead. The number of these non-voting nodes increases as M increases. In a scaled cluster (e.g., with M>=8), the probability that a voting node fails is significantly smaller than the probability that a non-voting node fails. This probability becomes smaller for larger clusters, which means the use of non-voting nodes becomes more beneficial at high cluster scales.

The “5-vote-quorum” scheme also performs well, when considering other common failure scenarios outside of network partition/failure domain failure. For instance, if two voting nodes fail, the “5-vote-quorum” scheme preserves quorum and allow service to continue.

Finally, note that in environments, where node failures are very common, it may be more optimal to choose a number larger than five to maintain quorum in the presence of a network partition, followed by failure of two or more nodes. In that case, the “5-vote-quorum” can be generalized as “K-vote-quorum”, where:

K=2P+1, P<M and P signifies the number of nodes, whose simultaneous failures the distributed system in question is to tolerate after a network partition. (Equation #1)

As described in further detail below, according to one embodiment, K is a static configuration parameter read by the nodes at system startup. In alternative embodiments, K can be automatically calculated and/or represent a dynamic parameter.

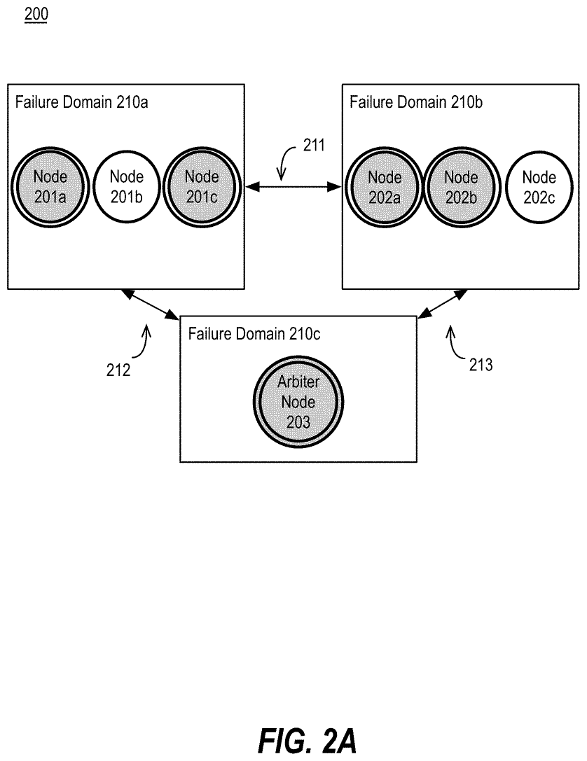

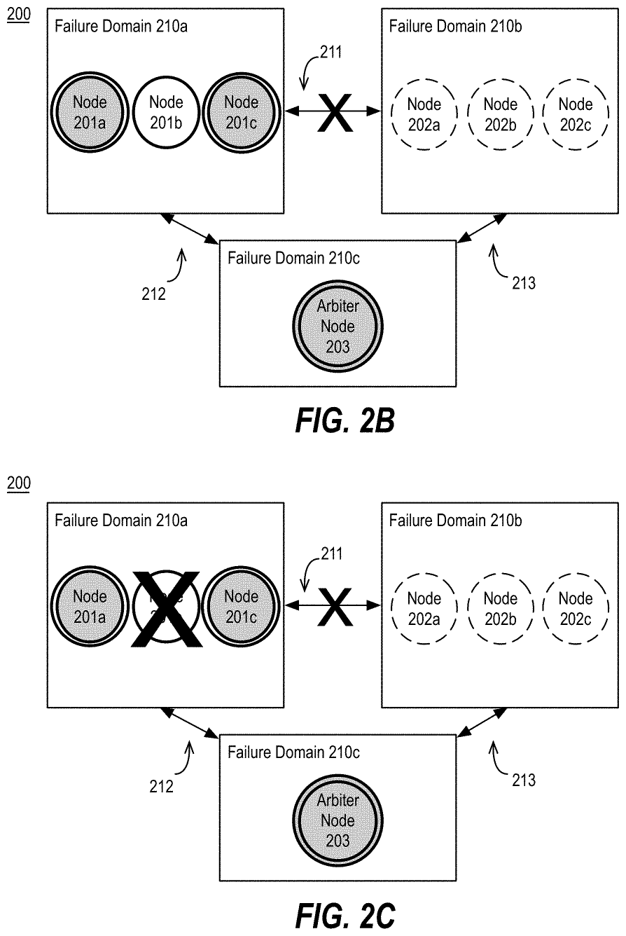

Referring now to FIG. 2A, a block diagram depicts a distributed system 200 with seven nodes 201a-c, 202a-c and 203 located in three different failure domains 210a-c and in which only a subset of the nodes are voters (i.e., nodes 201a, 201c, 202a, 202b and 203) in accordance with an embodiment. In the context of FIG. 2A, distributed system 200 is shown in a state in which a particular service supported or otherwise provided by nodes 201a-c, 202a-c and 203 is currently available and no failures have occurred.

In one embodiment, distributed system 200 may represent a stretch cluster system (e.g., a deployment model in which two or more physical or virtual servers are part of the same logical cluster, but are located in separate geographical locations to be able to survive localized disaster events).

As indicated above, it is desirable to spread nodes of a distributed system across multiple failure domains in order to avoid a potential single point of failure for the entire distributed system. In the context of the present example, the distributed system 200 is spread across three failure domains 210a-c, with nodes 201a-c operating within failure domain 210a, nodes 202a-c operating within failure domain 210b and an arbiter node 103 operating within failure domain 210c. Nodes 201a-c and nodes 202a-c make some contribution (e.g., processing, storage, etc.) to the operation of a particular service supported by distributed system 200. The role of arbiter node 203 is to act as a witness to maintain quorum for distributed system 200.

Three communication links 211, 212 and 213 couple the failure domains 210a-c in communication. Communication link 211, between failure domain 210a and failure domain 210b, facilitates communications (e.g., message passing and/or heartbeats) between nodes 201a-c and nodes 202a-c. Communication link 212, between failure domain 210a and failure domain 210c, facilitates communications between nodes 201a-c and arbiter node 203. Communication link 213, between failure domain 210b and failure domain 210c, facilitates communications between nodes 202a-c and arbiter node 203. As described above, links 211, 212 and 213 may be implemented as a networked communications system.

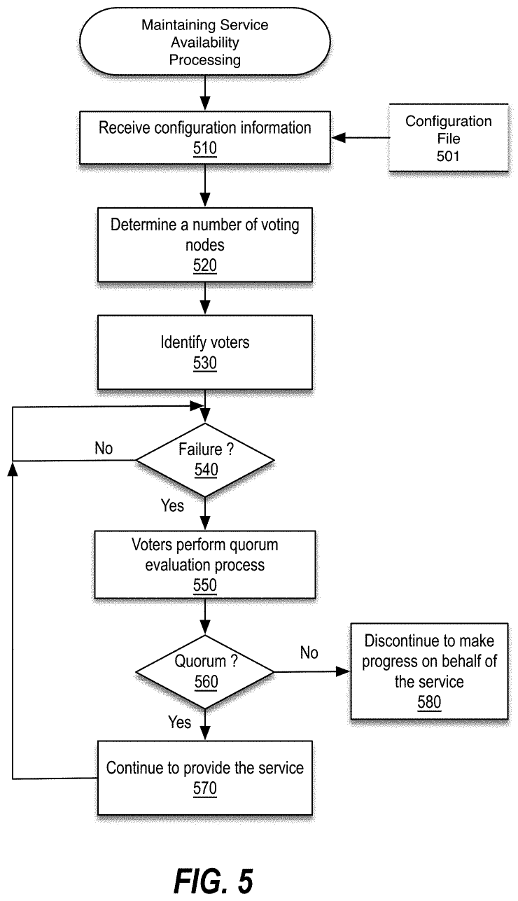

According to an embodiment, only a proper subset (i.e., less than all of the nodes of the distributed system 200) of the seven nodes 201a-c, 202a-c and 203 are voting nodes that participate in the quorum evaluation process employed by the distributed system 200. In the context of the present example, M=3. As such, in accordance with Rule #1 (above) five nodes vote (i.e., nodes 201a, 201c, 202a, 202b and 203) and three votes are required for quorum. An example approach for designating the voters and non-voters is described below with reference to FIG. 5.

In the context of the reduced quorum example described with reference to FIGS. 2A-2C, nodes depicted with bold outlines are part of an HA cluster that have quorum and are actively providing or supporting the particular service. Solid-filled nodes with double-outlined circles represent voters and single-outlined unfilled nodes are non-voters. Nodes shown with dashed outlines were part of the initial HA cluster configuration, but as a result of a failure have lost quorum and no longer make progress on behalf of the service.

FIG. 2B is a block diagram depicting the distributed system 200 of FIG. 2A after a network partition. In the context of the present example, a network failure of some kind (e.g., failure of a piece of networking equipment and/or a wireless or wired communication link between failure domain 210a and failure domain 210b) has isolated failure domain 210a from failure domain 210b. As such, both sides of the network partition determine whether they have quorum in order to seek reconstitution of the cluster to maintain service availability. Assuming arbiter node 203 has broken the 2-to-2 tie and has voted with nodes 201a and 201c, providing a 3 vote majority, this subset of the original set of nodes has quorum and continues to support the service on behalf of the HA cluster. Meanwhile, in parallel, nodes 202a-c have determined they do not have quorum and stop contributing to the service.

FIG. 2C is a block diagram depicting the distributed system 200 of FIG. 2B after a non-voter node failure. In the context of the present example, it is now assumed in addition to the network partition that occurred in FIG. 2B one of the non-voting nodes (i.e., node 201b) of the reconstituted HA cluster has failed. As the three remaining voters (i.e., nodes 201a, 201c and 203) retain quorum, they can continue servicing requests relating to the service. As such, an HA cluster implementing the “5-vote-quorum” scheme is able to tolerate two consecutive failures (i.e., a network partition followed by a non-voting node failure) while maintaining service availability. Meanwhile, as noted above, service availability provided by the “5-vote-quorum” scheme becomes better in the above-described two consecutive failure scenario as the probability of a voting node failing decreases as the cluster size grows, thereby making it advantageous for managed service providers and the like to deploy larger stretched clusters.

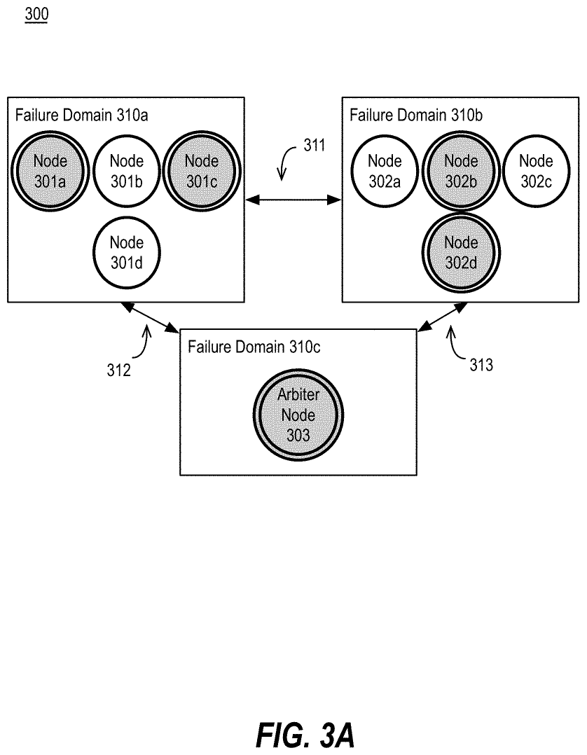

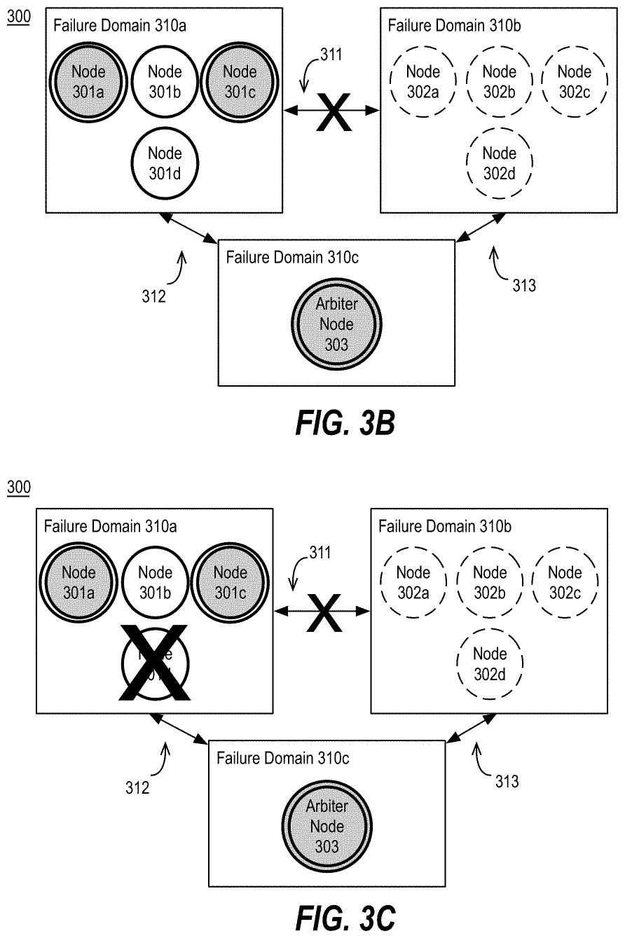

FIG. 3A is a block diagram depicting a distributed system 300 with nine nodes 301a-d, 302a-d and 303 located in three different failure domains 310a-c and in which only a subset of the nodes are voters (i.e., nodes 301a, 301c, 302b, 302d and 303) in accordance with an example embodiment. In the context of FIG. 3A, distributed system 300 is shown in a state in which a particular service supported or otherwise provided by nodes 301a-d, 302a-d and 303 is currently available and no failures have occurred.

In one embodiment, distributed system 300 may represent a stretch cluster system in which failure domains 310a-c are separate geographical locations. In the context of the present example, the distributed system 300 is spread across three failure domains 310a-c, with nodes 301a-d operating within failure domain 310a, nodes 302a-d operating within failure domain 310b and an arbiter node 303 operating within failure domain 310c. Nodes 301a-d and nodes 302a-d make some contribution (e.g., processing, storage, etc.) to the operation of a particular service supported by distributed system 300. The role of arbiter node 303 is to act as a witness to maintain quorum for distributed system 300.

Three communication links 311, 312 and 313 couple the failure domains 310a-c in communication. Communication link 311, between failure domain 310a and failure domain 310b, facilitates communications (e.g., message passing and/or heartbeats) between nodes 301a-d and nodes 302a-d. Communication link 312, between failure domain 310a and failure domain 310c, facilitates communications between nodes 301a-d and arbiter node 303. Communication link 313, between failure domain 310b and failure domain 310c, facilitates communications between nodes 302a-d and arbiter node 303.

According to an embodiment, only a proper subset (i.e., less than all of the nodes of the distributed system 300) of the nine nodes 301a-d, 302a-d and 303 are voting nodes that participate in the quorum evaluation process employed by the distributed system 300. In the context of the present example, M=4. As such, in accordance with Rule #1 (above), five nodes vote (i.e., nodes 301a, 301c, 302b, 303d and 303) and three votes are required for quorum.

Following the same convention used above in relation to FIGS. 2A-2C, in the context of the reduced quorum example described with reference to FIGS. 3A-3C, nodes depicted with bold outlines are part of an HA cluster that have quorum and are actively providing or supporting the particular service. Double-outlined, solid-filled nodes represent voters and singled-outlined, unfilled nodes are non-voters. Nodes shown with dashed outlines were part of the initial HA cluster configuration, but as a result of a failure have lost quorum and no longer make progress on behalf of the service.

FIG. 3B is a block diagram depicting the distributed system 300 of FIG. 3A after a network partition. In the context of the present example, a network failure of some kind has isolated failure domain 210a from failure domain 210b. As such, both sides of the network partition determine whether they have quorum in order to seek reconstitution of the cluster to maintain service availability. Assuming arbiter node 303 has broken the 2-to-2 tie and has voted with nodes 301a and 301c, providing a 3 vote majority, this subset of the original set of nodes has quorum and is able to continue to support the service on behalf of the HA cluster. Meanwhile, in parallel, nodes 302a-d have determined they do not have quorum and stop contributing to the service.

FIG. 3C is a block diagram depicting the distributed system of FIG. 3B after a non-voter node failure. In the context of the present example, it is now assumed in addition to the network partition that occurred in FIG. 3B one of the non-voting nodes (i.e., node 301d) of the reconstituted HA cluster has failed. As the three remaining voters (i.e., nodes 301a, 301c and 303) retain quorum, they can continue servicing requests relating to the service. As such, an HA cluster implementing the “5-vote-quorum” scheme is able to tolerate two consecutive failures (i.e., a network partition followed by a non-voting node failure) while maintaining service availability. Furthermore, as those skilled in the art will appreciate, this HA cluster configuration can tolerate one additional node failure so long as the failed node is the remaining non-voting node 301b. Again, it should be appreciated as the number of members of the stretch cluster grows (assuming the number of voters remains fixed and the number of non-voters is greater than the number of voters), the probability that a node failure impacts a non-voting node increases, thereby also increasing the likelihood that the stretch cluster will be able to tolerate the above-described two consecutive failure scenario and maintain service availability. This is in contrast to the decreasing likelihood of maintaining service availability as the cluster size grows provided by the “all-nodes-vote” quorum scheme discussed above with reference to FIGS. 1A-C.

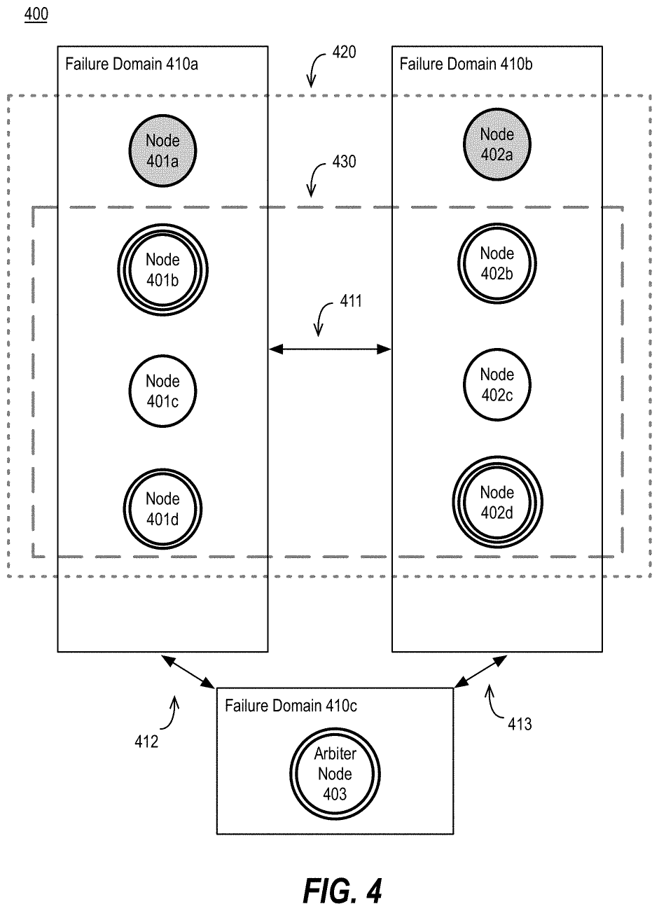

FIG. 4 is a block diagram depicting a distributed system 400 with nine nodes 401a-d, 402a-d and 403 supporting two different services 420 and 430 in accordance with an embodiment. The present example is intended to illustrate the per service nature of the role of a node as a voter or a non-voter according to one embodiment.

In the context of the present example, distributed system 400 is shown in a state in which two different services 420 and 430 supported or otherwise provided by nodes 401a-d, 402a-d and 403 are currently available and no failures have occurred.

As above, in one embodiment, distributed system 400 may represent a stretch cluster system in which failure domains 410a-c are separate geographical locations. In the context of the present example, the distributed system 400 is spread across three failure domains 410a-c, with nodes 401a-d operating within failure domain 410a, nodes 402a-d operating within failure domain 410b and an arbiter node 403 operating within failure domain 410c. Nodes 401a-d and nodes 402a-d make some contribution (e.g., processing, storage, etc.) to the operation of service 420 and a smaller group of nodes (i.e., nodes 401b-d and nodes 402b-d) make some contribution (e.g., processing, storage, etc.) to the operation of service 430.

The role of arbiter node 403 is to act as a witness to maintain quorum for distributed system 400. In one embodiment, the arbiter node 403 is able to service all nodes (401a-d and 402a-d) in both failure domains 410a and 410b. In an alternative embodiment, a separate arbiter may be provided within failure domain 410c for each service 420 and 430. In the context of the present example, arbiter node 403 is a voting node for both services 420 and 430.

Three communication links 411, 412 and 413 couple the failure domains 410a-c in communication. Communication link 411, between failure domain 410a and failure domain 410b, facilitates communications (e.g., message passing and/or heartbeats) between nodes 401a-d and nodes 402a-d. Communication link 412, between failure domain 410a and failure domain 410c, facilitates communications between nodes 401a-d and arbiter node 403. Communication link 413, between failure domain 410b and failure domain 410c, facilitates communications between nodes 402a-d and arbiter node 403.

According to an embodiment, only a proper subset (i.e., less than all of the nodes of the distributed system 400) of the nine nodes 401a-d, 402a-d and 403 are voting nodes that participate in the quorum evaluation process for service 420 employed by the distributed system 400. Similarly, only a proper subset (i.e., less than all of the nodes of the distributed system 400) of the nine nodes 401a-d, 402a-d and 403 are voting nodes that participate in the quorum evaluation process for service 430 employed by the distributed system 400.

In this example, a solid-filled circle is used to identify voters (i.e., nodes 401a and 402a) that only participate in the quorum evaluation process for service 420. A double-outlined circle is used to identify voters (i.e., nodes 401d, 402b and 403) that participate in the quorum evaluation process for both services 420 and 430. A triple-outlined circle is used to identify voters (i.e., nodes 401b and 402d) that only participate in the quorum evaluation process for service 430. And, a single-outlined circle is used to identify non-voters (i.e., nodes 401c and 402b) that do not participate in the quorum evaluation process for either of service 420 or service 430.

In the context of the present example, M=4 for service 420. As such, in accordance with Rule #2 (above), five nodes vote (i.e., nodes 401a, 401d, 402a, 402b and 403) and three votes are required for quorum. Similarly, M=3 for service 430. As such, in accordance with Rule #2 (above), five nodes vote (i.e., nodes 401b, 401d, 402b, 402d and 403) and three votes are required for quorum. As such, in a failure scenario involving two consecutive failures (i.e., a network partition in which failure domain 410a survives followed by a node failure impacting node 401b), service 430 would no longer have sufficient voting nodes to continue service, but service 420 would retain sufficient voting nodes (i.e., nodes 401a, 401d and 403) to maintain quorum and continue service.

While in the examples described above, distributed systems having seven and nine nodes are described as supporting one or two different services, those skilled in the art will appreciate the flexibility of the reduced quorum approach described herein is also applicable to distributed systems having more or fewer nodes and supporting more services. Similarly, while for simplicity, the examples described above illustrate three failure domains, those skilled in the art will appreciate the reduced quorum approach described herein is equally applicable to distributed systems having nodes spread across more failure domains. Additionally, while the examples described above illustrate HA clusters implementing a “5-vote-quorum” scheme, it is specifically contemplated that the “5-vote-quorum” can be generalized as a “K-vote-quorum” so as to, among other things, provide a cluster administrator with the ability configure the distributed system with a value of K based on their preferred balance among the trade-offs of failure tolerance, performance and cost. For example, as noted above, in an environment in which node failures are more common, the cluster administrator may wish to choose a number larger than five to maintain quorum in the presence of a network partition, followed by failure of two or more nodes.

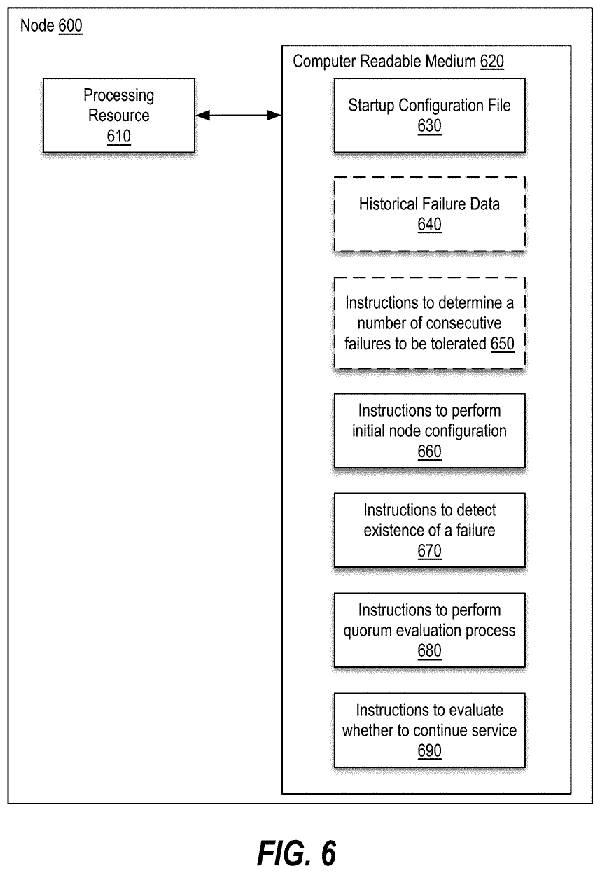

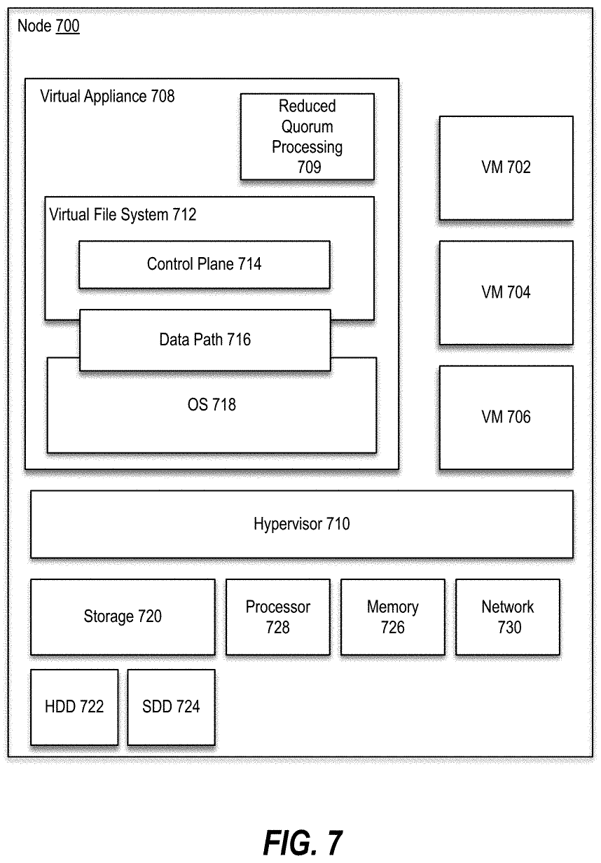

FIG. 5 is a flow diagram illustrating distributed system processing in accordance with an embodiment. The processing described with reference to FIG. 5 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, this processing may be performed by one or more nodes of various forms, such as the nodes described with reference to FIG. 6 and/or FIG. 7 below. For sake of brevity, this flow diagram and the below description focus on processing related to various aspects of the reduced quorum functionality. Those skilled in the art will appreciate various other processing (e.g., the operations and processes performed in connection with providing or otherwise supporting a particular service by the distributed service or a particular service provided by a user of the distributed system).

At block 510, the distributed system, receives configuration information. For example, as each node of the distributed system starts up, they may read various configuration parameters from a configuration file 501 and perform appropriate initialization and configuration processing based thereon. The configuration file 501 may be stored locally on each node or may be accessed from a shared location. According to one embodiment, the configuration file 101 includes, among other configuration parameters and information, a quorum configuration parameter from which the number of voting nodes that are to participate in quorum evaluation processing for each service supported by the distributed system can be determined. For example, in the context of the “K-vote-quorum” scheme described above in which K=2P+1, P<M and P signifies the number of nodes whose simultaneous failures the distributed system in question is to tolerate after a network partition, depending upon the particular implementation, the quorum configuration parameter may specify K (the number of voters) or P (the number of node failures to be tolerated).

At block 520, the distributed system determines a number of voting nodes for each service supported by the distributed system. In one embodiment, the number of voting nodes is based on the quorum configuration parameter for the service. Alternatively, if no quorum configuration parameter is specified, Rule #1 and Rule #2 (described above in connection with the “5-vote-quorum” scheme) can be used as a default based on the number of nodes in the distributed system. Also, as described further below, it may also be that parameter K is determined dynamically.

At block 530, the distributed system identifies the voters. In one embodiment, each node of the distributed system has access to an ordered list of nodes (e.g., sorted in ascending alphanumeric order by unique identifiers associated with the nodes) (and information associated therewith) that are part of the distributed system. For example, a startup configuration file (e.g., configuration file 501) may provide one or more of a globally unique identifier (GUID), a name, an Internet Protocol (IP) address, and a global ordering rank of each of the nodes. In one embodiment, based on information regarding the distributed system that is accessible to each of the nodes as well as the quorum configuration parameter, the distributed system identifies the voters. For example, each node may sort (e.g., in ascending alphanumeric order) the list of nodes by a unique identifier (e.g., a GUID) associated with the nodes. In accordance with a set of predefined and/or configurable rules, each node may then traverse the sorted list to identify which nodes are in the voting quorum. Those skilled in the art will appreciate there are many ways in which this can be done, including, but not limited to: (i) allowing the service/application to choose; (ii) choosing the nodes in a random fashion; and (iii) employing a separate balancing service to decide this while also ensuring that voter responsibilities are spread across all of the nodes in the cluster, so that no particular node is overloaded with voting responsibilities.

According to one embodiment, to the extent weighting is used in the particular implementation, the nodes can be weighted in accordance with their relative importance to the service. For example, nodes that either perform some special computation or have access to special data can be assigned higher weight than nodes that do not have this special knowledge/data. At this point, after the nodes of the distributed system have completed their respective configuration processing, each node may enter their respective operational modes, including launching processes associated with supporting a particular service.

At decision block 540, the distributed system determines whether a failure has occurred.

According to one embodiment, each of the nodes of the distributed system sends a heartbeat to all others. The heartbeat may be a periodic signal generated by hardware or software to indicate ongoing normal operation. For example, the heartbeat may be sent at a regular interval on the order of seconds. In one embodiment, if a node does not receive a heartbeat from another node for a predetermined or configurable amount of time—usually one or more heartbeat intervals—the node that should have sent the heartbeat is assumed to have failed. In an alternative implementation, partial connectivity may exist. Consider, for example, three nodes A, B, and C. A and B can talk to each other. A can also talk to C but B cannot talk to C. Suppose that A has the capability to forward messages between B and C. In this case, even though C does not receive heartbeats directly from B, it may receive heartbeats from B forwarded by C. So, in order to declare some node X to be failed there may need to be an agreement among the surviving nodes that they do not see X.

Those skilled in the art will appreciate there are a variety of ways to determine the existence of a failure in the context of a distributed system. For example, in alternative embodiments, a pull approach may be used rather than a push approach, in which each node polls all others regarding their status. In one embodiment, heartbeats may be service specific. In an alternative implementation, a heartbeat/failure detection service may be implemented separately from the nodes associated with the distributed service. In the latter case, decisions of this separate failure detection service would be evaluated by each service to see whether quorum may be affected, and, if so, quorum re-evaluation can be triggered. Regardless of the particular mechanism used to determine a failure, if one is determined to exist, then processing continues with block 550; otherwise, failure monitoring/detection processing continues by looping back to decision block 540.

At block 550, responsive to detection of existence of a failure, the voters associated with the particular service exhibiting the failure perform a quorum evaluation process to determine whether they can continue the particular service. As those skilled in the art will appreciate, there are a variety of algorithms and protocols that may be used to perform quorum evaluation. In one embodiment, all nodes of the distributed system implement the Paxos algorithm to determine existence of quorum; however, the particular quorum evaluation process is unimportant in the context of this disclosure.

At decision block 560, the quorum evaluation process of each voter determines whether the node is part of a remaining set of nodes that have quorum. If so, then processing continues with block 570; otherwise, processing branches to block 580.

At block 570, it has been determined that the node at issue is part of the quorum. As such, the node can continue to provide the service. Those skilled in the art will appreciate that certain types of failures (e.g., a network partition) may involve reconstitution, such as in the manner described above with reference to FIGS. 2B and 3B. At this point, the node continues processing requests relating to the service and monitoring/detecting failures by looping back to decision block 540.

At block 580, it has been determined that the node at issue is not part of the quorum. As such, the node no longer processes requests relating to the service and discontinues to make progress on behalf of the service.

In the context of the above example, K may be provided as a static configuration parameter. For example, a user (e.g., a service provider) utilizing a distributed system in accordance with an example embodiment described herein may configure the “optimal” value of K (the number of voters) independently for each service in a multi-service HA cluster. As those skilled in the art will appreciate, in order to enable quorum decisions, K is an odd number. In one embodiment, the user would choose K based on the number of simultaneous node failures the service is desired to tolerate without becoming unavailable. For instance, imagine a service that is deployed on a stretch cluster including sixteen nodes and the user would like the service to tolerate up to four simultaneous node failures. In this case, in accordance with Equation #1, the user should choose K=9. The value of K is chosen by the user based on their desired trade-off of failure tolerance versus performance and cost. Recall, as noted above, that the lower the value of K, the more scalable the service (since communication between voters increases with K factorial (K!)). On the other hand, a higher value of K enables the service to tolerate more simultaneous node failures. The user can optimize K based on the type of distributed service, the cost associated with its unavailability, the probability of individual node failure, and the need for scale. Additionally, in some embodiments, in this type of distributed system, the user will also be allowed to change the value of K for a given service once the service is already running (as long as the majority of its voters are present to make a decision, K can be modified at runtime). In some implementations, K may also be specified and applied as a dynamic parameter.

While in the context of the above example, K is specified by a user such as an administrator, in alternative embodiments, the knowledge of what is “optimal” can be based on prior execution history. As such, in one embodiment, statistical data about failures (e.g., network partitions and/or node failures) can be collected and based thereon K may be increased or decreased dynamically to maximize service availability in the presence of simultaneous node failures. Such a service could be programmed to start with some default value of K (e.g., 5) and then it can be modified dynamically based on the types of node failures observed. For instance, in a 16-node system, if the service observes that simultaneous 4-node outages are “common”, it can dynamically increase K to 9. (As in the section above, having the majority of voters present to make a decision is sufficient to adjust the value of K). Stated more generally, in some implementations, K may be determined dynamically based on prior history and a policy specified by the user. For instance, K may be dynamically increased to the maximal number of previously observed simultaneous node failures (not involving failure domain failure/partition) if such failures have been observed X times over the specified time interval Y. The number K may also be automatically decreased if no simultaneous failure of X nodes has been observed over some larger N*Y time interval.

In addition to or alternatively to dynamically altering K at runtime, K can be determined at startup based on the statistical data and used as a static quorum configuration parameter. In another embodiment, rather than calculating K based on historical statistical data, K can be predicted based on known failure characteristics and/or predicted failure modes of the nodes associated with the distributed system.

Embodiments described herein include various steps, examples of which have been described above. As described further below, these steps may be performed by hardware components or may be embodied in machine-executable instructions, which may be used to cause a general-purpose or special-purpose processor programmed with the instructions to perform the steps. Alternatively, at least some steps may be performed by a combination of hardware, software, and/or firmware.

Embodiments described herein may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to example embodiments described herein with appropriate standard computer hardware to execute the code contained therein. An apparatus for practicing various embodiments described herein may involve one or more computing elements or computers (or one or more processors within a single computer) and storage systems containing or having network access to computer program(s) coded in accordance with various methods described herein, and the method steps of various embodiments described herein may be accomplished by modules, routines, subroutines, or subparts of a computer program product.

FIG. 6 is a block diagram of a node 600 of a distributed system in accordance with an example embodiment. In the simplified example illustrated by FIG. 6, node 600 includes a processing resource 610 coupled to a non-transitory, machine readable medium 720 encoded with instructions to maintain service availability for a distributed system. The processing resource 610 may include a microcontroller, a microprocessor, central processing unit core(s), an ASIC, an FPGA, and/or other hardware device suitable for retrieval and/or execution of instructions from the machine readable medium 620 to perform the functions related to various examples described herein. Additionally or alternatively, the processing resource 610 may include electronic circuitry for performing the functionality of the instructions described herein.

The machine readable medium 620 may be any medium suitable for storing executable instructions. Non-limiting examples of machine readable medium 620 include RAM, ROM, EEPROM, flash memory, a hard disk drive, an optical disc, or the like. The machine readable medium 620 may be disposed within the node 600, as shown in FIG. 6, in which case the executable instructions may be deemed “installed” or “embedded” on the node 600. Alternatively, the machine readable medium 620 may be a portable (e.g., external) storage medium, and may be part of an “installation package.” The instructions stored on the machine readable medium 620 may be useful for implementing at least part of the methods described herein.

As described further herein below, the machine readable medium 620 may have stored thereon a startup configuration file 630 and optional historical failure data 640 and may be encoded with a set of executable instructions 650, 660, 670, 680, and 690. It should be understood that part or all of the executable instructions and/or electronic circuits included within one box may, in alternate implementations, be included in a different box shown in the figures or in a different box not shown. Notably, boxes 640 and 650 are shown with dashed outlines to make it clear that historical failure data 640 and the associated set of instructions 650 to process same are optional in this embodiment.

According to one embodiment, startup configuration file 630 specifies various configuration parameters, including K, and provides information (e.g., GUIDs, IP addresses, names, and the like) regarding multiple nodes associated with the distributed system. As noted above, in alternative embodiments, K may be calculated based on another type of quorum configuration parameter (e.g., P, the number of consecutive node failures desired to be tolerated) specified within the startup configuration file 630.

In some implementations, optional historical failure data 640 may represent statistical data about failures (e.g., consecutive node failures, which occur outside of failure domain failure/partition scenarios) observed during runtime for a predetermined and/or configurable historical timeframe (e.g., the last 24 hours, the previous X days, the previous Y weeks, the previous Z months, or the like).

In some implementations, optional instructions 650, upon execution, cause the processing resource 610 to evaluate statistical data calculated based on or part of historical failure data 740 and calculate a value for K based thereon. In this manner, K may be automatically calculated to maximize service availability in the presence of simultaneous node failures based on prior observations regarding provision of the service by the distributed system. For example, as noted above, in a 16-node distributed system, if the distributed system observes that simultaneous 4-node outages are “common”, it can determine an appropriate value for K is 9. As such, this calculated value of K can be used as a static system startup parameter and/or as a dynamic parameter that can alter the configuration of the dynamic system during runtime.

Instructions 660, upon execution, cause the processing resource 610 to perform initial node configuration, including, for example, reading of the startup configuration file 630, identifying the voters for each service supported by the distributed system and when the node at issue is one of the voters, then configuring the node to participate in a quorum evaluation process responsive to detection of a failure. In one embodiment, instructions 660 may correspond generally to instructions for performing blocks 510, 520 and 530 of FIG. 5.

Instructions 670, upon execution, cause the processing resource 610 to detect existence of a failure of another of the nodes associated with the distributed system. For example, each node may maintain a data structure containing information, for each service supported by the distributed system, the time at which the last heartbeat for the particular service was received. This data structure may be periodically evaluated to determine if a predetermined or configurable node failure time threshold has elapsed, for example, without receipt of a heartbeat for a node/service pair. In one embodiment, if a node does not receive a heartbeat from another node for the node failure time threshold, the node that should have sent the heartbeat is assumed to have failed. Execution of instructions 670 may correspond generally to instructions for performing decision block 540 of FIG. 5.

Instructions 680, upon execution, cause the processing resource 610 to perform a quorum evaluation processes. In one embodiment, responsive to detecting existence of a failure relating to a particular service, in order to determine whether they can continue the particular service, only the voters associated with the particular service perform a quorum evaluation process. In one embodiment, the quorum evaluation process includes performing the Paxos algorithm. In other embodiments, different quorum evaluation processes/protocols may be employed. Execution of instructions 680 may correspond generally to instructions for performing block 550 of FIG. 5. Instructions 690, upon execution, cause the processing resource 610 to evaluate whether to continue service. In one embodiment, based on completion of performance of a quorum evaluation process, each voting node determines whether it is part of a set of remaining nodes that have quorum. If so, then the set of remaining nodes continue to provide service; otherwise, the set of remaining nodes discontinue providing the service. Execution of instructions 680 and 690 may correspond generally to instructions for performing blocks 560, 570, and 580 of FIG. 5. In one embodiment, a node that finds itself part of a subset without quorum stops service until such time that it finds itself again as part of the subset that has quorum (presumably because of failure recovery), at which point it is able once again to provide service

FIG. 7 is a block diagram illustrating a HyperConverged Infrastructure (HCI) node 700 that may represent the nodes of a distributed system in accordance with an embodiment. In the context of the present example, node 700 has a software-centric architecture that integrates compute, storage, networking and virtualization resources and other technologies. For example, node 700 can be a commercially available system such as HPE SimpliVity 380 incorporating an OnmiStack® file system available from Hewlett Packard Enterprise of San Jose, Calif.

Node 700 may be implemented as a physical server (e.g., a server having an x86 or x64 architecture) or other suitable computing device. In the present example, node 700 hosts a number of guest virtual machines (VM) 702, 704 and 706, and can be configured to produce local and remote backups and snapshots of the virtual machines. In some embodiments, multiple of such nodes, each performing reduced quorum processing 709 (such as that described above in connection with FIG. 5), may be coupled to a network and configured as part of a cluster. Depending upon the particular implementation, one or more services supported by the distributed system may be related to VMs 702, 704 and 706 or may be unrelated.

Node 700 can include a virtual appliance 708 above a hypervisor 710. Virtual appliance 708 can include a virtual file system 712 in communication with a control plane 714 and a data path 716. Control plane 714 can handle data flow between applications and resources within node 700. Data path 716 can provide a suitable Input/Output (I/O) interface between virtual file system 712 and an operating system (OS) 718, and can also enable features such as data compression, deduplication, and optimization. According to one embodiment the virtual appliance 708 represents a virtual controller configured to run storage stack software (not shown) that may be used to perform functions such as managing access by VMs 702, 704 and 706 to storage 720, providing dynamic resource sharing, moving VM data between storage resources 722 and 724, providing data movement, and/or performing other hyperconverged data center functions.

Node 700 can also include a number of hardware components below hypervisor 710. For example, node 700 can include storage 720 which can be Redundant Array of Independent Disks (RAID) storage having a number of hard disk drives (HDDs) 722 and/or solid state drives (SSDs) 724. Node 700 can also include memory 726 (e.g., RAM, ROM, flash, etc.) and one or more processors 728. Lastly, node 700 can include wireless and/or wired network interface components 130 to enable communication over a network (e.g., with other nodes or with the Internet).

In the foregoing description, numerous details are set forth to provide an understanding of the subject matter disclosed herein. However, implementation may be practiced without some or all of these details. Other implementations may include modifications and variations from the details discussed above. It is intended that the following claims cover such modifications and variations.

What is claimed is:

1. A method comprising:
establishing at system startup, by a distributed computer system comprising a plurality of nodes coupled in communication via a network, a number of the plurality of nodes to operate as voters in a quorum evaluation process performed by the distributed system for a service supported by the plurality of nodes;
identifying, by the distributed computer system, a first proper subset of the plurality of nodes to operate as the voters, wherein a remaining subset of the plurality of nodes not in the first proper subset do not vote in the quorum evaluation process;
responsive to detecting, by a voter of the voters, an existence of a failure scenario that results in the voter being part of a second proper subset of nodes of the plurality of nodes and that calls for a quorum evaluation, determining, by the voter, whether the second proper subset of nodes has a quorum by initiating the quorum evaluation process;
when said determining is affirmative, then continuing, by the second proper subset of nodes to support the service; and
when said determining is negative, then discontinuing, by the second proper subset of the nodes to make progress on behalf of the service.

2. The method of claim 1, wherein said establishing comprises receiving, by the distributed computer system, configuration information specifying of a number of consecutive node failures, other than failure domain failures or network partitions, the service is desired to tolerate.

3. The method of claim 1, wherein the plurality of nodes comprises an odd number of nodes larger than 5.

4. The method of claim 3, wherein one or more of the plurality of nodes comprise a hyperconverged infrastructure node that integrates at least virtualized compute and storage resources.

5. The method of claim 4, wherein the plurality of nodes are part of a high-availability (HA) stretch cluster.

6. The method of claim 1, wherein the plurality of nodes provide a plurality of services and wherein for each particular service of the plurality of services a particular node supports, the particular node is configured to operate as a voter or a non-voter for purposes of a quorum evaluation process relating to the particular service.

7. The method of claim 6, wherein said identifying includes balancing the voters across the plurality of services.

8. The method of claim 1, wherein the plurality of nodes comprises a first portion of nodes within a first failure domain, a second portion of nodes within a second failure domain and an arbiter node within a third failure domain and operable to distinguish between (i) a fault in the first failure domain or a fault in a second failure domain and (ii) a partition in communication between the first failure domain and the second failure domain and wherein the arbiter node is one of the voters.

9. The method of claim 1, wherein votes of the voters are weighted equally.

10. The method of claim 1, wherein votes of one or more of the voters are weighted differently based on their relative importance to the service.

11. The method of claim 1, further comprising calculating the number of the plurality of nodes to operate as voters based on a predicted or historically experienced likelihood of consecutive node failures, not including failure domain failures or network partitions.

12. A distributed system comprising:
a first set of nodes of a plurality of nodes operating within a first failure domain;
a second set of nodes of the plurality of nodes operating within a second failure domain coupled in communication with the first failure domain;
wherein each node of the plurality of nodes includes:
a processing resource; and
a non-transitory computer-readable medium, coupled to the processing resource, having stored therein instructions that when executed by the processing resource cause the processing resource to:
establish at system startup a number of the plurality of nodes to operate as voters in a quorum evaluation process for a service supported by the plurality of nodes;
identify a first proper subset of the plurality of nodes to operate as the voters, wherein a remaining subset of the plurality of nodes not in the first proper subset do not vote in the quorum evaluation process;
responsive to a failure that results in a voter of the voters being part of a second proper subset of nodes of the plurality of nodes and that calls for a quorum evaluation, determining, by the voter, whether the second proper subset of nodes has a quorum by initiating the quorum evaluation process;
when said determining is affirmative, then continuing, by the second proper subset of nodes to support the service; and
when said determining is negative, then discontinuing, by the second proper subset of the nodes to make progress on behalf of the service.

13. The distributed system of claim 12, wherein the number of the plurality of nodes to operate as voters is established by receiving configuration information specifying of a number of consecutive node failures, not including failure domain failures or network partitions, the service is desired to tolerate.

14. The distributed system of claim 12, wherein the plurality of nodes comprises an odd number of nodes larger than 5.

15. The distributed system of claim 14, wherein the plurality of nodes are part of a high-availability (HA) stretch cluster of hyperconverged infrastructure nodes that integrate at least virtualized compute and storage resources.

16. The distributed system of claim 12, further comprising an arbiter node within a third failure domain coupled in communication with the first failure domain and the second failure domain and operable to distinguish between (i) a fault in the first failure domain or a fault in a second failure domain and (ii) a partition in communication between the first failure domain and the second failure domain and wherein the arbiter node is one of the voters.

17. A non-transitory machine readable medium storing instructions executable by a processing resource of a distributed system comprising a plurality of nodes coupled in communication via a network, the non-transitory machine readable medium comprising:
instructions to establish at system startup a number of the plurality of nodes to operate as voters in a quorum evaluation process performed by the distributed system for a service supported by the plurality of nodes;
instructions to identify a first proper subset of the plurality of nodes to operate as the voters, wherein a remaining subset of the plurality of nodes not in the first proper subset do not vote in the quorum evaluation process;
instructions, responsive to a failure that results in a voter of the voters being part of a second proper subset of nodes of the plurality of nodes and that calls for a quorum evaluation, to determine, by the voter, whether the second proper subset of nodes has a quorum by initiating the quorum evaluation process;
instructions, responsive to the determination being affirmative, to continue by the second proper subset of nodes to support the service; and
instructions, responsive to the determination being negative, to discontinue by the second proper subset of the nodes to make progress on behalf of the service.

18. The non-transitory machine readable medium of claim 17, wherein the number of the plurality of nodes to operate as voters is established by receiving configuration information specifying of a number of consecutive node failures, not including failure domain failures or network partitions, the service is desired to tolerate.

19. The non-transitory machine readable medium of claim 17, wherein the plurality of nodes are part of a high-availability (HA) stretch cluster of hyperconverged infrastructure nodes that integrate at least virtualized compute and storage resources.

20. The non-transitory machine readable medium of claim 17, further comprising instructions to calculate the number of the plurality of nodes to operate as voters based on a predicted or historically experienced likelihood of node failures, excluding failure domain failures.
